(19) United States
(12) Patent Application Publication
(10) Pub. No.: US 2013/0230309 A1
(43) Pub. Date: Sep. 5, 2013

(54) OPTICAL SCOPE COUPLERS

(71) Applicant: DESIGNPORT, INC., Salem, OR (US)

(72) Inventors: Douglas Roy Porter, Salem, OR (US); Ken Courian, Portland, OR (US)

(73) Assignee: DESIGNPORT, INC., Salem, OR (US)

(21) Appl. No.: 13/782,904

(22) Filed: Mar. 1, 2013

Related U.S. Application Data
(60) Provisional application No. 61/606,111, filed on Mar. 2, 2012.
(60) Provisional application No. 61/614,934, filed on Mar. 23, 2012.
(60) Provisional application No. 61/727,598, filed on Nov. 16, 2012.

(51) Int. Cl. G02B 21/36

(52) U.S. Cl. CPC G02B 21/36
USPC 396/432

(57) ABSTRACT

Camera accessories configured to couple a camera having a camera optical axis and a scope having a scope optical axis are disclosed. Additionally, camera accessories configured to couple a smart phone having a camera with a camera optical axis and a scope having a scope optical axis are disclosed. The camera accessory may include a locking mechanism configured to selectively secure the portion of the scope to the scope-receiving assembly such that, when the camera is attached to the camera-receiving assembly and when the scope is received by the scope-receiving assembly, the camera optical axis coincides with the scope optical axis.

### CROSS-REFERENCE TO RELATED APPLICATIONS

This application claims priority to U.S. Provisional Patent Application Ser. No. 61/606,111, which was filed on Mar. 2, 2012 and entitled “Optical Scope Couplers and Camera Holders;” U.S. Provisional Patent Application Ser. No. 61/614,934, which was filed on Mar. 23, 2012 and entitled “Optical Scope Couplers and Camera Holders;” and U.S. Provisional Patent Application Ser. No. 61/727,598, which was filed on Nov. 16, 2012 and entitled “Optical Scope Couplers and Camera Holders.” The complete disclosures of the above applications are hereby incorporated by reference for all purposes.

### BACKGROUND OF THE DISCLOSURE

Cameras may be coupled to optical scopes via optical scope couplers to record images visible through the optical scopes. For example, a camera may be mounted to a telescope or spotting scope. The activity of using a camera to record distant images by coupling it with an optical scope (or optical lens) is referred to as “digiscoping.”

Couplers, camera holders, and/or other camera accessories may be used to couple the camera and the optical scope. Examples of couplers and/or camera holders are described in U.S. Pat. Nos. 5,053,794; 4,862,199; 4,844,071; 4,807,594; 4,740,058; 4,723,864; 4,318,395; 4,143,938; 2,765,718; and U.S. Patent Application Publication No. 2002/0197075. The complete disclosures of the above patent applications and patent application publication are hereby incorporated by reference for all purposes.

### SUMMARY OF THE DISCLOSURE

The present disclosure is directed to a camera accessory configured to couple a camera having a camera optical axis to a scope having a scope optical axis. The camera accessory may include a scope-receiving assembly having a first end portion configured to receive a portion of the scope and a second end portion spaced from the first end portion. The camera accessory may additionally include a camera-receiving assembly attached to, or formed with, the second end portion and including a lens mount configured to connect to the lens mounting plate of the camera. The camera accessory may further include a locking mechanism configured to selectively secure the portion of the scope to the scope-receiving assembly such that, when the camera is attached to the camera-receiving assembly and when the scope is received by the scope-receiving assembly, the camera optical axis coincides with the scope optical axis.

The locking mechanism may include a locking element having at least one wall that forms a portion of a circular aperture. The locking mechanism may additionally include an adjustment element configured to move the locking element between a locking position in which the circular aperture has a first diameter such that the at least one wall fits snugly around at least a substantial portion of a perimeter of the portion of the scope, and an unlocking position in which the circular aperture has a second diameter larger than the first diameter such that the at least one wall is spaced from the at least a substantial portion of a perimeter of the portion of the scope.

The present disclosure is also directed to a camera accessory configured to couple a smart phone having a camera with a camera optical axis and a scope having a scope optical axis, the smart phone including top and bottom surfaces and a plurality of sides. The camera accessory may include a scope-receiving assembly having a first end portion configured to receive a portion of the scope and a second end portion spaced from the first end portion. The camera accessory may additionally include a camera-receiving assembly attached to the second end portion and configured to receive the smart phone. The camera-receiving assembly may include a base, and a plurality of retention elements movably attached to the base and configured to contact and support two or more sides of the plurality of sides. The camera accessory may further include a locking mechanism configured to selectively secure the portion of the scope to the scope-receiving assembly.

The locking mechanism may include a locking element having at least one wall that forms a portion of a circular aperture, and an adjustment element configured to move the locking element between a locking position in which the circular aperture has a first diameter such that the at least one wall fits snugly around at least a substantial portion of a perimeter of the portion of the scope, and an unlocking position in which the circular aperture has a second diameter larger than the first diameter such that the at least one wall is spaced from the at least a substantial portion of a perimeter of the portion of the scope. The camera-receiving assembly and the locking mechanism may be configured such that, when the smart phone having a camera is received by the camera-receiving assembly and the portion of the scope is received by the scope-receiving assembly, the camera optical axis coincides with the scope optical axis.

### BRIEF DESCRIPTION OF THE DRAWINGS

FIG. 1 is a block diagram of an example of an optical scope coupler.

FIG. 2 is a block diagram of another example of an optical scope coupler.

FIG. 3 is an isometric view of an example of an optical scope coupler of FIGS. 1-2 shown coupling a scope and a camera.

FIGS. 4-5 are isometric views of the optical scope coupler of FIG. 3.

FIG. 6 is an isometric view of another example of an optical scope coupler of FIGS. 1-2 shown coupling a scope and a camera.

FIG. 7 is an isometric view of a further example of an optical scope coupler of FIGS. 1-2.

FIG. 8 is an exploded view of the optical scope coupler of FIG. 3.

FIG. 9 is a partial sectional view of the optical scope coupler of FIG. 3 taken along lines 9-9 in FIG. 4, showing a locking element in an unlocking position.

FIG. 10 is a sectional view of the optical scope coupler of FIG. 3 taken along lines 10-10 in FIG. 4, showing a locking element in the unlocking position of FIG. 9.

FIG. 11 is the partial sectional view of FIG. 9, showing the locking element in a locking position.

FIG. 12 is the sectional view of FIG. 10, showing the locking element in the locking position of FIG. 11.

FIG. 13 is an isometric view of another example of a locking element having first and second strips.

FIG. 14 is a partial sectional view of the optical scope coupler of FIG. 3 taken along lines 9-9 in FIG. 4, showing the locking element of FIG. 13 and showing an additional strip in dashed lines separated from the rest of the locking element.

FIG. 15 is a sectional view of the optical scope coupler of FIG. 3 taken along lines 9-9, shown without an adjustment element and with an example of a filter.

FIG. 16 is an isometric view of a further example of an optical scope coupler of FIGS. 1-2 shown coupling a scope and a camera.

FIGS. 17-18 are isometric views of the optical scope coupler of FIG. 16.

FIG. 19 is a partial exploded view of the optical scope coupler of FIG. 16.

FIG. 20 is an exploded view of the clamping assembly of the optical scope coupler of FIG. 16.

FIG. 21 is a sectional view of a clamping assembly of the optical scope coupler of FIG. 14 taken along lines 21-21 in FIG. 19, showing the clamping assembly in a fully open position.

FIG. 22 is a sectional view of the clamping assembly of FIG. 21 in a fully closed position.

FIG. 23 is an isometric view of another example of an optical scope coupler of FIGS. 1-2.

### DETAILED DESCRIPTION OF THE DISCLOSURE

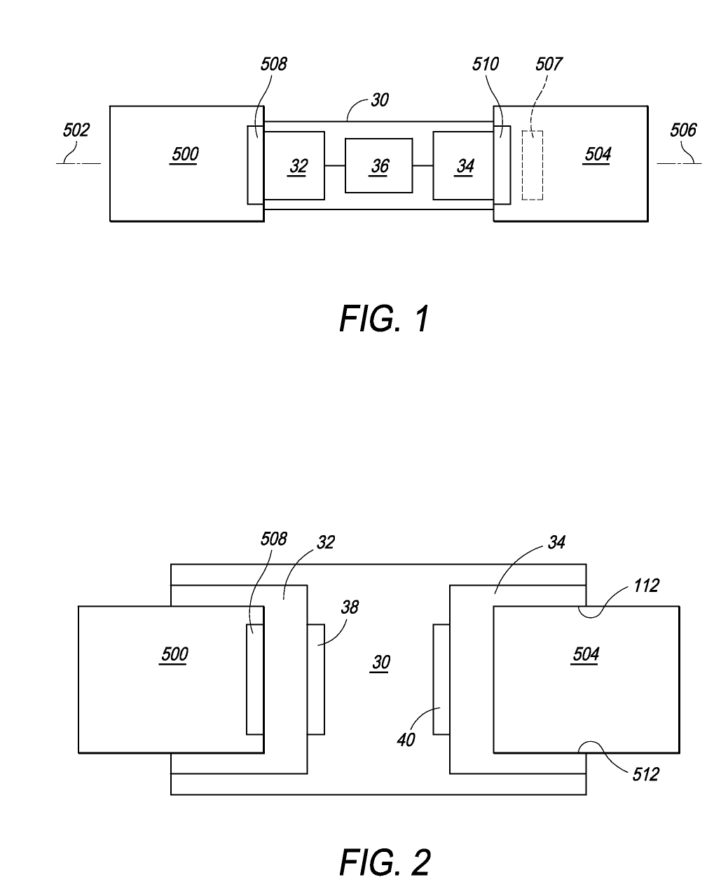

FIG. 1 shows an example of an optical scope coupler 30, which may include any suitable structure configured to couple an optical scope 500 having a scope optical axis 502 and a camera 504 having a camera optical axis 506 such that, for example, the scope optical axis overlaps or coincides (or generally overlaps or generally coincides) with the scope optical axis. In other words, the camera optical axis and the scope optical axis are aligned or generally aligned. The optical scope coupler may sometimes be referred to as a “camera accessory,” “camera adapter,” or “scope adapter.”

Examples of optical scopes 500 include telescopes, spotting scopes, monoculars, binoculars, microscopes, riflescopes, pocketscopes, proctoscopes, endoscopes, etc. Examples of cameras 504 include digital cameras, single lens reflex (SLR) cameras, viewfinder cameras, video or movie cameras, video surveillance cameras, camera phones, smart phones having a camera, etc. In some examples, camera 504 may include any device that includes a charge-coupled device (CCD) or CCD image sensor 507 configured to capture images. Camera 504 may be configured to capture images in the visible and/or non-visible wavelength range(s), such as infrared, millimeter, and/or ultraviolet wavelength ranges.

The scope optical axis defines a path along which light propagates through the optical scope, while the camera optical axis defines a path along which light propagates through the camera. The optical axis also may be described as a line along which there is some degree of rotational symmetry in the optical scope or the camera. When the scope and camera optical axes are aligned or coincident, light propagates through the optical scope and through the camera (the image from the scope is transmitted to the film or sensor of the camera).

For example, optical scope coupler 30 may include a scope-receiving assembly 32, a camera-receiving assembly 34, and a locking assembly 36, as shown in FIG. 1. The scope-receiving assembly may include any suitable structure configured to receive, mount, and/or attach to one or more portions of optical scope 500. For example, scope-receiving assembly 32 may be attached to a portion of the optical scope, such as an eyepiece 508 (or a portion of that eyepiece), via any suitable attachment structure(s). Alternatively, or additionally, scope-receiving assembly 32 may be configured to receive a portion of the optical scope, such as the eyepiece (or a portion of that eyepiece), as shown in FIG. 2.

Camera-receiving assembly 34 may include any suitable structure configured to receive, mount, and/or attach to one or more portions of camera 504. For example, the camera-receiving assembly may be attached to a lens mounting plate 510 of the camera. Alternatively, or additionally, camera-receiving assembly 34 may be configured to receive one or more portions of the camera, such as one or more sides 512 of the camera, as shown in FIG. 2.

Locking assembly 36 may include any suitable structure configured to secure one or more portions of the optical scope to the scope-receiving assembly and/or one or more portions of the camera to the camera-receiving assembly. For example, the locking assembly may include a first locking mechanism 38 configured to secure one or more portions of the optical scope to the scope-receiving assembly, and a second locking mechanism 40 configured to secure one or more portions of the camera to the camera-receiving assembly, as shown in FIG. 2.

Although scope-receiving assembly 32 and camera-receiving assembly 34 are shown to either attach to optical scope 500 and camera 504 or receive the optical scope and the camera, other examples of optical scope coupler 30 may include one of the receiving assemblies being attached to the optical scope or camera and the other of the receiving assemblies receiving one or more portions of the optical scope or camera. For example, another example of optical scope coupler may include a scope-receiving assembly 32 that is configured to receive a portion of the optical scope (such as the eyepiece or a portion of the eyepiece) and a camera-receiving assembly 34 that is configured to be attached to camera (such as to the lens mounting plate). Additionally, although locking assembly 36 is shown to include the first and second locking mechanisms, the locking assembly may include only the first locking mechanism or only the second locking mechanism.

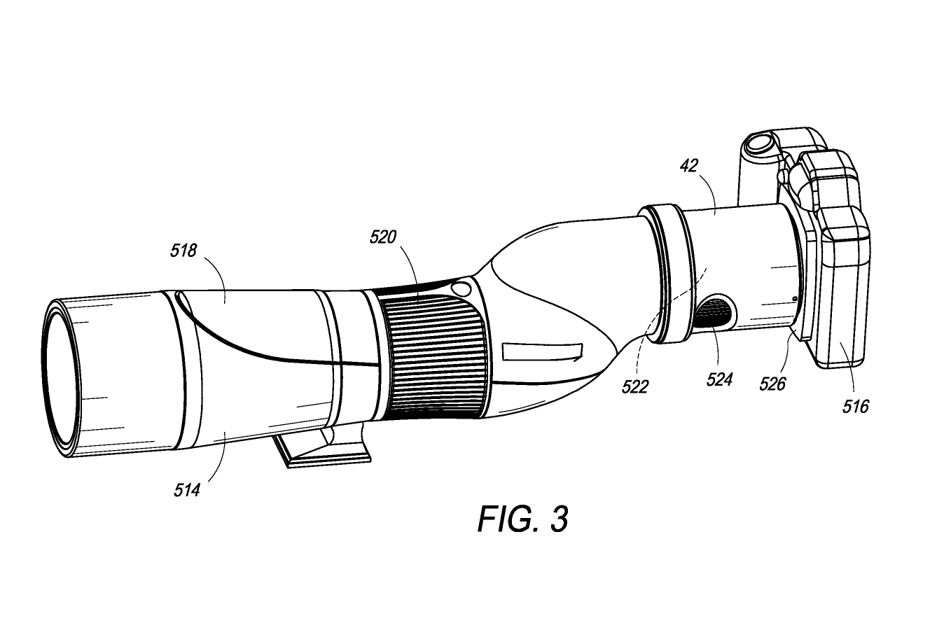

An example of optical scope coupler 30 is generally indicated at 42 in FIG. 3. Unless explicitly stated otherwise, optical scope coupler 42 may include one or more components of one or more other optical scope couplers described in the present disclosure. Optical scope coupler 42 is shown coupling a spotting scope 514 and a SLR camera 516 such that the scope optical axis of the spotting scope coincides with the camera optical axis of the SLR camera. The spotting scope includes a scope base 518, a first adjustment ring 520, an eyepiece 522, and a second adjustment ring 524, as shown in FIG. 3. The first adjustment ring may be rotatably connected to the scope base and may allow a user to adjust focus (or zoom/focal length) of the spotting scope. The second adjustment ring may be rotatably connected to the eyepiece (or the scope base) and may allow a user to adjust zoom/focal length (or focus) of the spotting scope.

SLR camera 516 may include a lens mounting plate 526, which may be configured to attach to optical scope coupler 42 (or a lens). The lens mounting plate may include a plurality of recesses and/or a plurality of threads (not shown). Although optical scope coupler 42 is shown in FIG. 3 to couple spotting scope 514 and SLR camera 516, the optical scope coupler may alternatively, or additionally, be configured to couple any suitable optical scope and any suitable camera.

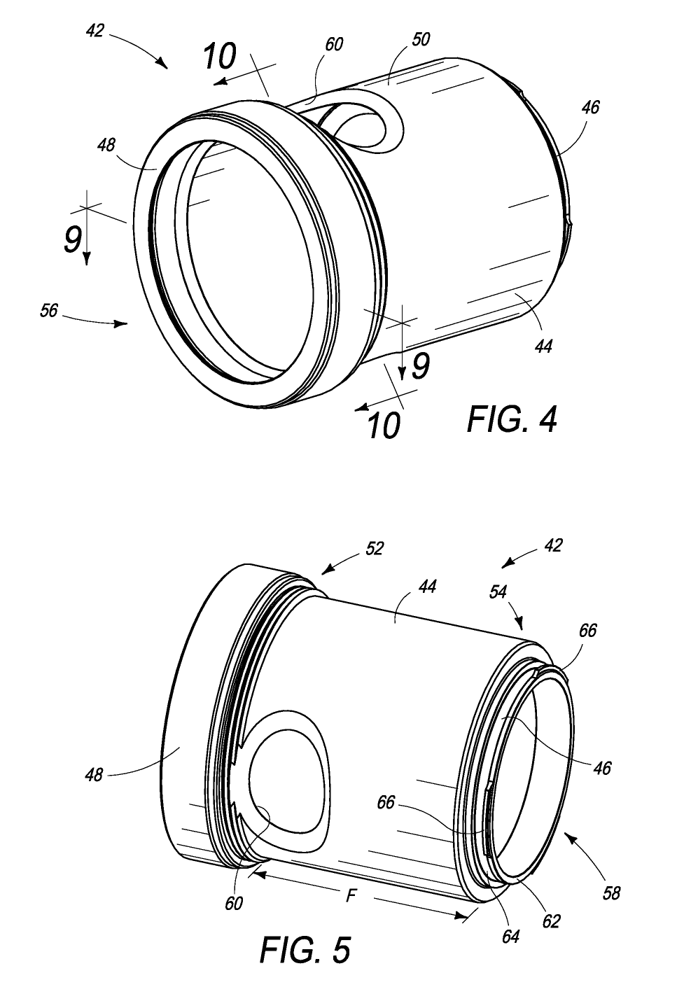

Optical scope coupler 42 may include a scope-receiving assembly 44, a camera-receiving assembly 46, and a locking mechanism 48, as shown in FIGS. 4-5. Scope-receiving assembly 44 may include any suitable structure configured to receive and/or enclose any suitable portion(s) of an optical scope, such as spotting scope 514. For example, the scope-receiving assembly may include a base structure 50 having a first end portion 52 and a second end portion 54. The first end portion may include a first opening 56 configured to receive any suitable portion(s) of spotting scope 514, such as eyepiece 522. The second end portion may be spaced from the first end portion and may include a second opening 58 that is, for example, co-axial with the first opening.

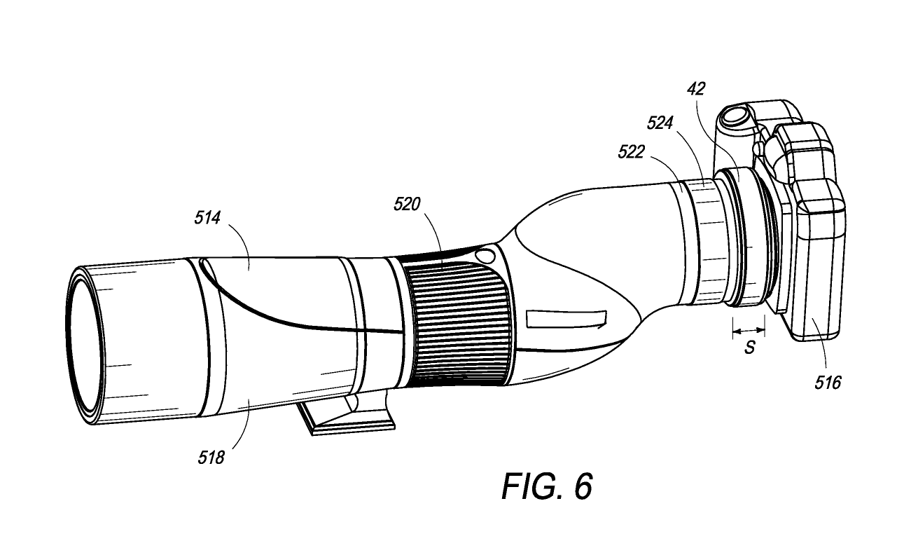

The base structure may have any suitable shape(s). For example, base structure 50 may have a cylindrical (or generally cylindrical) shape. Alternatively, the base structure may be shaped like a sphere, a cone, a prism, a pyramid, and/or suitable combinations of two or more of the above shapes. Additionally, base structure 50 may include any suitable dimension(s). For example, the base structure may include a first length F such that second adjustment ring 524 is fully enclosed when spotting scope 514 is received by the base structure (and such that a locking element of the locking mechanism does not contact the adjustment ring in the locking position, as further discussed below). Alternatively, the base structure may include a second length S shorter than the first length such that second adjustment ring is only partially enclosed or not enclosed, as shown in FIG. 6. In other words, at least a portion of second adjustment ring (or the entire second adjustment ring) is external base structure 50 when spotting scope 514 is received in the base structure (and a locking element of the locking mechanism may contact the second adjustment ring in the locking position).

In some examples, as shown in FIGS. 4-5, base structure 50 may include at least one hole 60 configured to allow a user to access and/or move second adjustment ring 524 and/or other components of spotting scope 514 external the base structure when the spotting scope is received by the base structure. The hole may be any suitable size(s) and/or shape(s).

Camera-receiving assembly 46 may include any suitable structure configured to be attached to SLR camera 516. The camera-receiving assembly may be attached to or formed with second end portion 54 of scope-receiving assembly 44. Camera-receiving assembly 46 may, for example, include a lens mount 62 (shown in FIGS. 4-5) configured to connect to lens mounting plate 526 of SLR camera 516.

The lens mount may include any suitable structure configured to attach to the lens mounting plate of the SLR camera. For example, as shown in FIGS. 4-5, lens mount 62 may include a connection ring 64 having a plurality of tabs 66 configured to be received in the lens mounting plate, such as in a plurality of recesses of the lens mounting plate. The plurality of tabs may be sized and spaced to correspond to particular models or brands of SLR cameras. Alternatively, or additionally, connection ring 64 may include a plurality of threads 68, as shown in FIG. 7. The plurality of threads may be configured to connect to the lens mounting plate, such as to a plurality of threads of the lens mounting plate.

Although lens mount 62 is shown to include connection ring 64 having a plurality of tabs 66 and/or a plurality of threads 68, the lens mount may include any suitable structure configured to connect or attach to lens mounting plate 526. For example, lens mount 62 may alternatively, or additionally, include connection ring 64 having a plurality of recesses, slots, apertures, posts, etc.

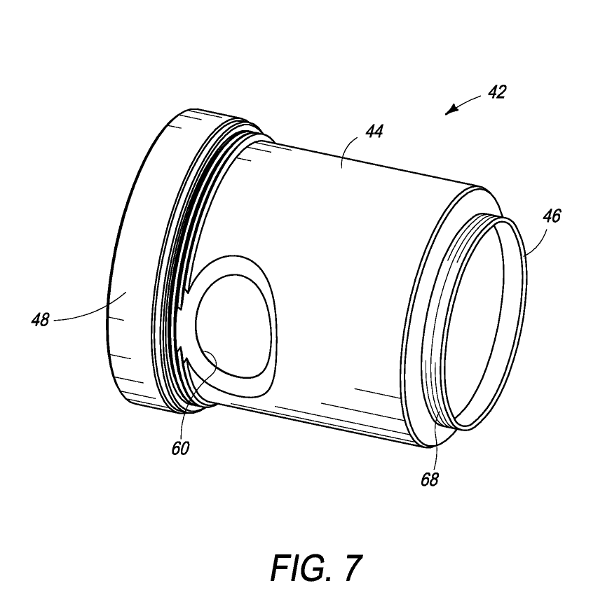

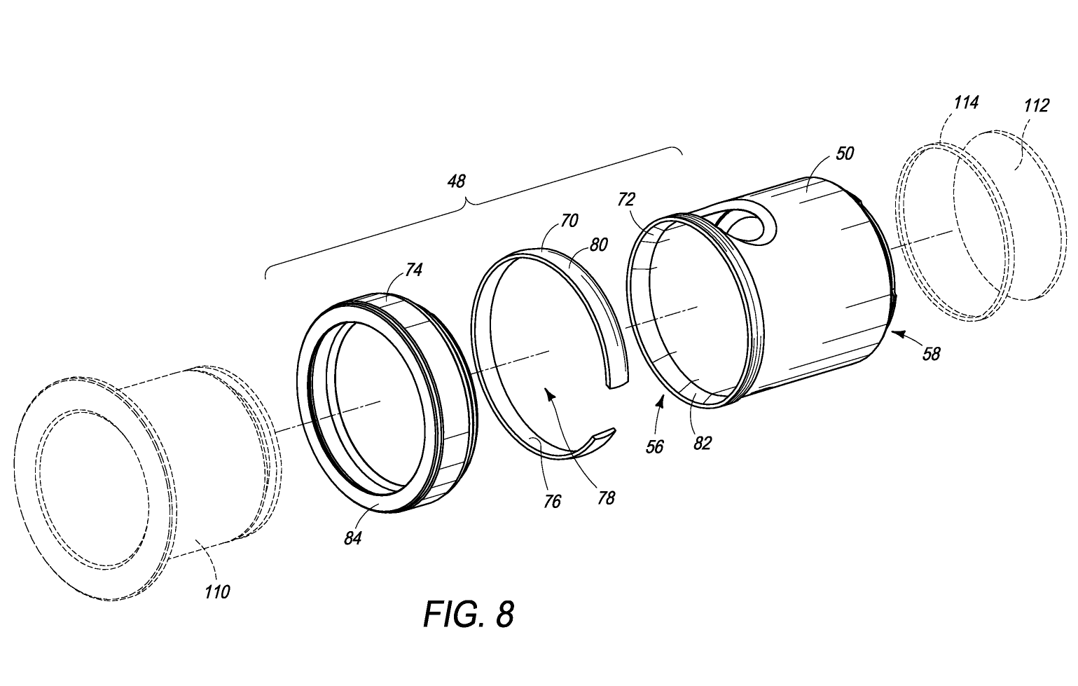

Locking mechanism 48 may include any suitable structure configured to selectively secure one or more portions of the spotting scope to the scope-receiving assembly such that the camera optical axis coincides with the scope optical axis when the optical scope coupler couples the SLR camera and spotting scope. For example, the locking mechanism may include a locking element 70, a base element 72, and an adjustment element 74, as shown in FIG. 8.

The locking element may include any suitable structure having at least one wall 76 that forms a portion of a circular aperture 78. For example, locking element 70 may include a ferrule or a first strip 80 having a shape that forms a portion of circular aperture 78. Base element 72 may support locking element 70 within first opening 56. The base element may include any suitable structure attached to, or formed with, first end portion 52. For example, base element 72 may include a base inclined surface 82.

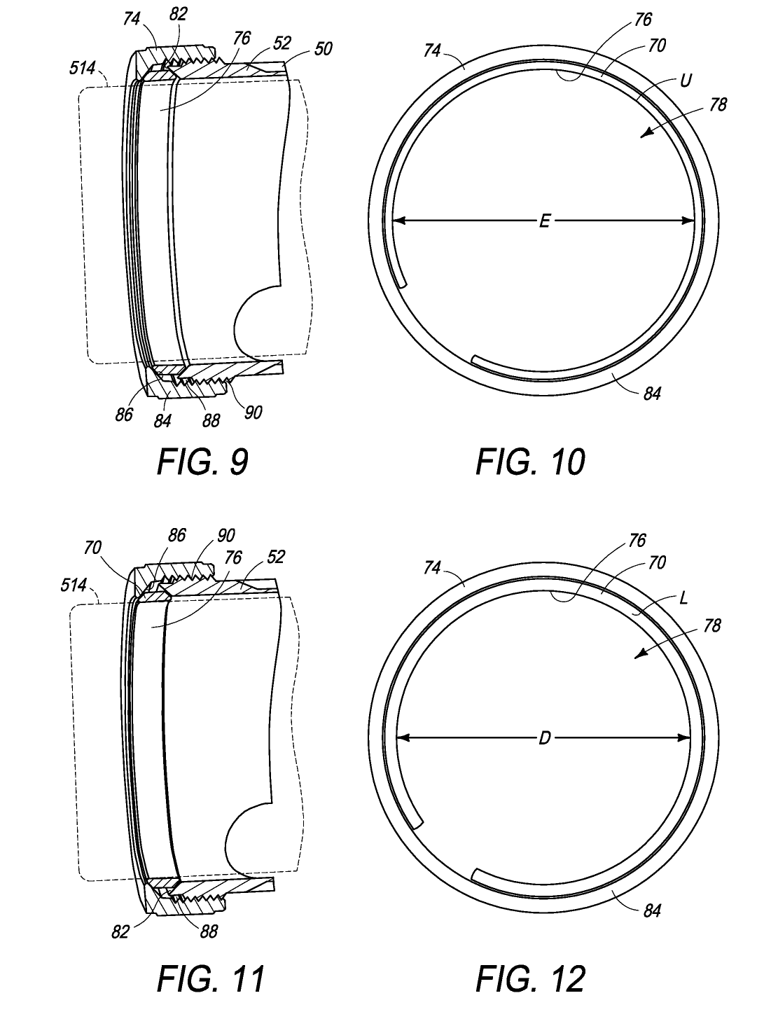

Adjustment element 74 may include any suitable structure configured to move locking element 70 between a locking position L shown in FIGS. 11-12 in which circular aperture 78 has a first diameter D such that wall 76 fits snugly around at least a substantial portion of a perimeter of the portion of the scope received by the base structure, and an unlocking position U shown in FIGS. 9-10 in which circular aperture 78 has a second diameter E that is larger than first diameter D such that wall 76 is spaced from the perimeter of the portion of the scope received by the base structure.

Depending on the size of the portion of the spotting scope received by the base structure, wall 76 may fit snugly around the entire perimeter (or a portion of that perimeter) in the locking position. Note that the locking element has been exaggerated in FIG. 12 only to illustrate the change in diameter. In some examples, the locking element may be configured to return to second diameter E when free from, for example, any force from the adjustment element. In other words, the locking element may be biased toward maintaining the second diameter and the adjustment element moves the locking element against that bias to the first diameter.

Adjustment element 74 may, for example, include an outer ring 84 that is configured to be movably coupled, such as rotatably coupled, to first end portion 52 of base structure 50. The outer ring may include structure configured to move the locking element between the locking and unlocking positions via rotation of the outer ring relative to the base structure. For example, outer ring 84 may include a ring inclined surface 86 and a plurality of threads 88 that are configured to engage plurality of threads 90 of first end portion 52. When the outer ring is rotated to engage more of the threads of the first end portion (toward the first end portion), the locking element may be compressed and moved from the unlocking position to the locking position. In contrast, when the ring is rotated to disengage more of the threads of the first end portion (away from the first end portion), the locking element may be allowed to return to the unlocking position. The locking element may sometimes be described as being compressible by a single adjustment element while keeping the received portion of the spotting scope centered such that the scope optical axis is maintained in alignment with the camera optical axis.

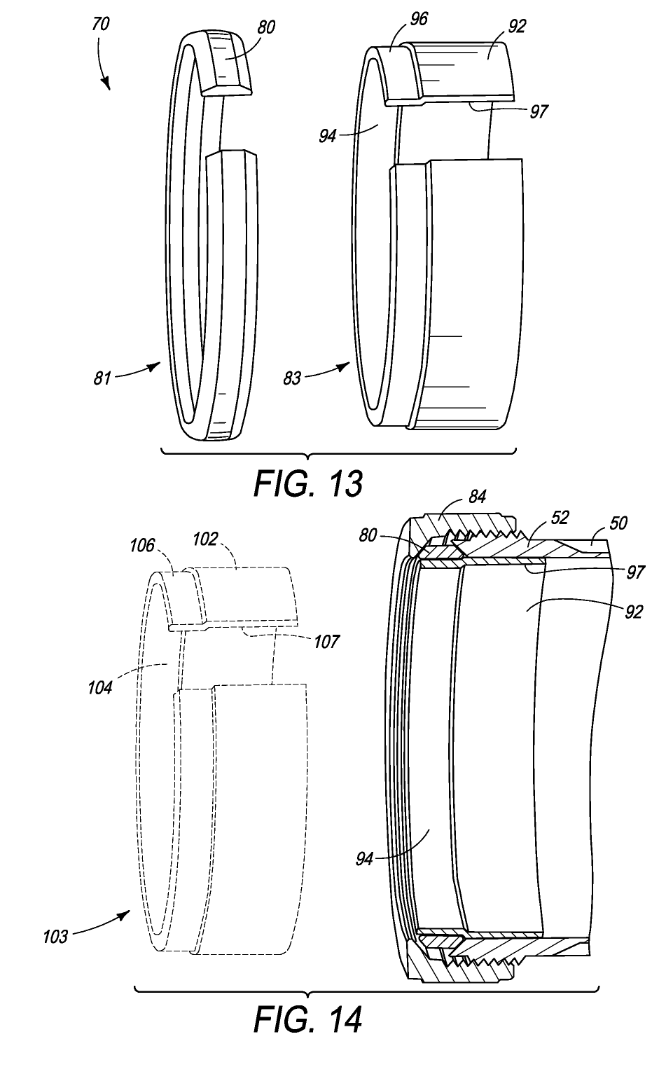

In some examples, as shown in FIG. 13, locking element 70 may include a first strip 80 and a second strip (or first spacer) 92 configured to nest within first strip 80, such as within a circular aperture formed by the first strip. In other words, the first strip may form a portion of a first circular aperture 81, while the second strip may form a portion of a second circular aperture 83 that has a diameter smaller than the first circular aperture when nested within the first circular aperture. When adjustment element 74 moves first strip 80, the first strip moves the second strip. For example, when adjustment element 74 decreases the diameter of the circular aperture formed by the first strip, the first strip decreases the diameter of the circular aperture formed by the second strip.

Second strip 92 may include at least one wall 94, which, when used with the first strip, may fit snugly around at least a substantial portion of the perimeter of the portion of the scope received within the base structure when moved to the locking position, and is spaced from the perimeter of the portion of the scope received within the base structure when moved to the unlocking position.

In some examples, the second strip may include a first groove or channel 96 sized to receive a portion of the first strip to facilitate nesting of the second strip within the circular aperture formed by the first strip. Additionally, or alternatively, the second strip may include a second groove or channel 97 sized to receive a portion of a third strip to facilitate nesting of the third strip within the circular aperture formed by the second strip, as further described below. Although second strip 92 is shown to include first groove 96 and/or second groove 97, the first strip may include groove(s) and/or other suitable structure(s) and the second strip may include tab(s) and/or other suitable structure(s). For example, second strip may include tab(s) sized to be received within groove(s) of the first strip to facilitate nesting of the second strip within the circular aperture formed by the first strip.

In some examples, as shown in FIG. 14, locking element 70 may include a first strip 80, a second strip (or first spacer) 92 configured to nest within first strip 80, and a third strip (or second spacer) 102 configured to nest within the second strip, such as within a circular aperture formed by the second strip. In other words, the first strip may form a portion of a first circular aperture, the second strip may form a portion of a second circular aperture that has a diameter smaller than the first circular aperture when the second strip is nested within the first circular aperture, and the third strip may form a portion of a third circular aperture 103 that has a diameter smaller than the second circular aperture when the third strip is nested within the second circular aperture. When adjustment element 74 moves first strip 80, the first strip moves the second strip and the second strip moves the third strip. For example, when adjustment element 74 decreases the diameter of the first circular aperture formed by the first strip, the first strip decreases the diameter of the second circular aperture formed by the second strip, and the second strip decreases the diameter of the third circular aperture formed by the third strip.

Third strip 102 may include at least one wall 104, which, when used with the first and second strips, fits snugly around at least a substantial portion of the perimeter of the portion of the scope received within the base structure when moved to the locking position, and is spaced from the perimeter of the portion of the scope received within the base structure when moved to the unlocking position.

In some examples, the third strip may include a third groove or channel 106 sized to receive a portion of the second strip to facilitate nesting of the third strip within the circular aperture formed by the second strip. Additionally, or alternatively, the third strip may include a fourth groove or channel 107 sized to receive a portion of a fourth strip (not shown) to facilitate nesting of the fourth strip within the circular aperture formed by the third strip. Although third strip 102 is shown to include third groove 106 and/or fourth groove 107, the second strip may include grooves and/or other suitable structure(s) and the third strip may include tab(s) and/or other suitable structure(s). For example, the third strip may include tab(s) sized to be received within groove(s) of the second strip to facilitate nesting of the third strip within the circular aperture formed by the second strip. Although locking element 70 is shown to include up to three strips, the locking element may include four, five, six, seven, or more strips nested within each other to accommodate a variety of optical scopes.

The optical scope coupler may include a protective cap 110, as shown in FIG. 8, which may be configured to be received in first opening 56 of base structure 50. The protective cap may protect the interior components of SLR camera 516 when the optical scope coupler is attached to the SLR camera but not attached to the spotting scope or other optical scope.

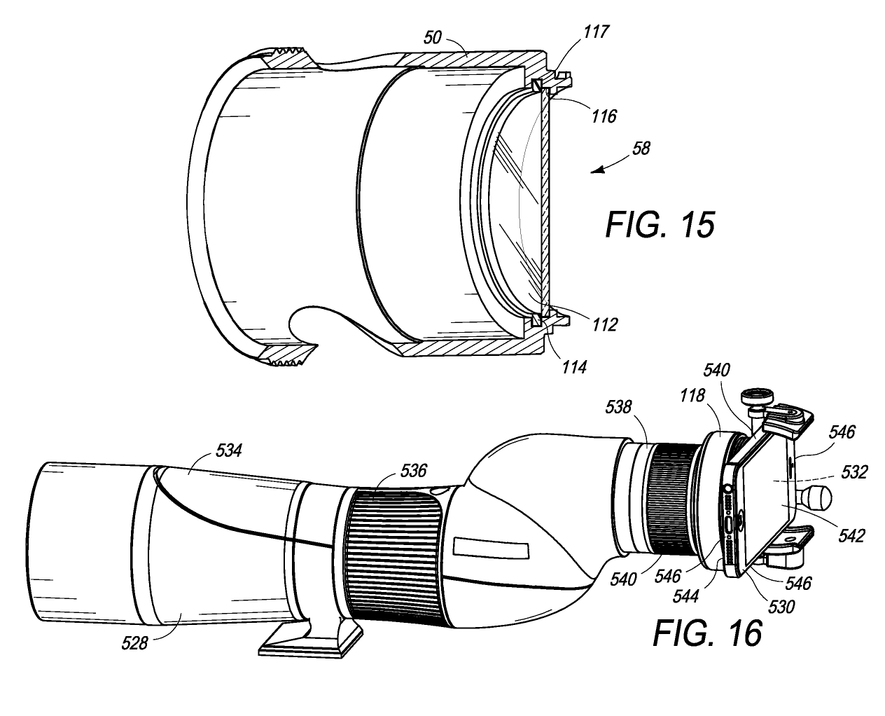

In some examples, optical scope coupler may include at least one filter 112 and at least one support element 114, as shown in FIG. 8. Filter 112 may be any suitable filter configured to protect interior components of the camera from external contaminants and/or modify image(s). For example, filter 112 may include one or more clear filters, skylight filters, ultraviolet filters, polarizing filters, optically coated filters and/or color filters, etc. The filter may, for example, be configured to protect interior components of the camera (such as from external contaminants) when the SLR camera is connected to the camera-receiving structure but the scope is not received by the base structure. The filter may be retained adjacent to second opening 58 via support element 114. The support element may be in the form of an o-ring or a filter frame. For example, as shown in FIG. 15, filter 112 may be received within a first base groove 116 and support element 114 may be received within a second base groove 117.

Although filter 112 and support element 114 are shown to be discrete components, filter 112 may be mounted to, or formed with, support element 114. Additionally, although filter 112 and support element 114 are shown to be received with the first and second base grooves, the filter and/or support element may be attached to the base structure via any suitable mechanism(s), such as via complementary threaded portions of the second end portion and the support element.

In some examples, optical scope coupler 42 may not include any lenses (or is free from one or more lenses). “Lenses” refer to structure(s) that capture light from a subject and bring the light to a focus on film or a detector (such as CCD 507). The optical scope coupler may be configured to couple the SLR camera (or any suitable camera) and the spotting scope (or any suitable optical scope) without any lenses. When the optical scope coupler does not include any lenses, that coupler may still include one or more filters 112, as described above. When the SLR camera includes CCD 507, the optical scope coupler may be configured to be free from one or more lenses such that the optical scope coupler is configured to couple the spotting scope and the SLR camera without one or more lenses disposed between the eyepiece of the scope and the CCD (may sometimes be referred to as providing for “direct CCD transmission” of the image from the spotting scope to the SLR camera).

Alternatively, the optical scope coupler may include one or more lenses (not shown), such as coated and/or specially ground lenses. When the optical scope coupler includes one or more lenses, the optical scope coupler may sometimes be referred to as providing for “lensed transmission” of the image from the spotting scope to the SLR camera.

Another example of optical scope coupler 30 is generally indicated at 118 in FIG. 16. Unless explicitly stated otherwise, optical scope coupler 118 may include one or more components of one or more other optical scope couplers described in the present disclosure. Optical scope coupler 118 is shown coupling a spotting scope 528 and a smart phone 530 having a camera 532 such that the scope optical axis of the spotting scope coincides with the camera optical axis of camera 532.

The spotting scope includes a scope base 534, a first adjustment ring 536, an eyepiece 538, and a second adjustment ring 540, as shown in FIG. 16. The first adjustment ring may be rotatably connected to the scope base and may allow a user to adjust focus (or zoom/focal length) of the spotting scope. The second adjustment ring may be rotatably connected to the eyepiece (or the scope base) and may allow a user to adjust zoom/focal length (or focus) of the spotting scope.

Smart phone 530 may include a top surface 542, a bottom surface 544, and a plurality of sides 546. Although optical scope coupler 118 is shown in FIG. 16 to couple spotting scope 528 and smart phone 530, the optical scope coupler may alternatively, or additionally, be configured to couple any suitable optical scope and any suitable camera.

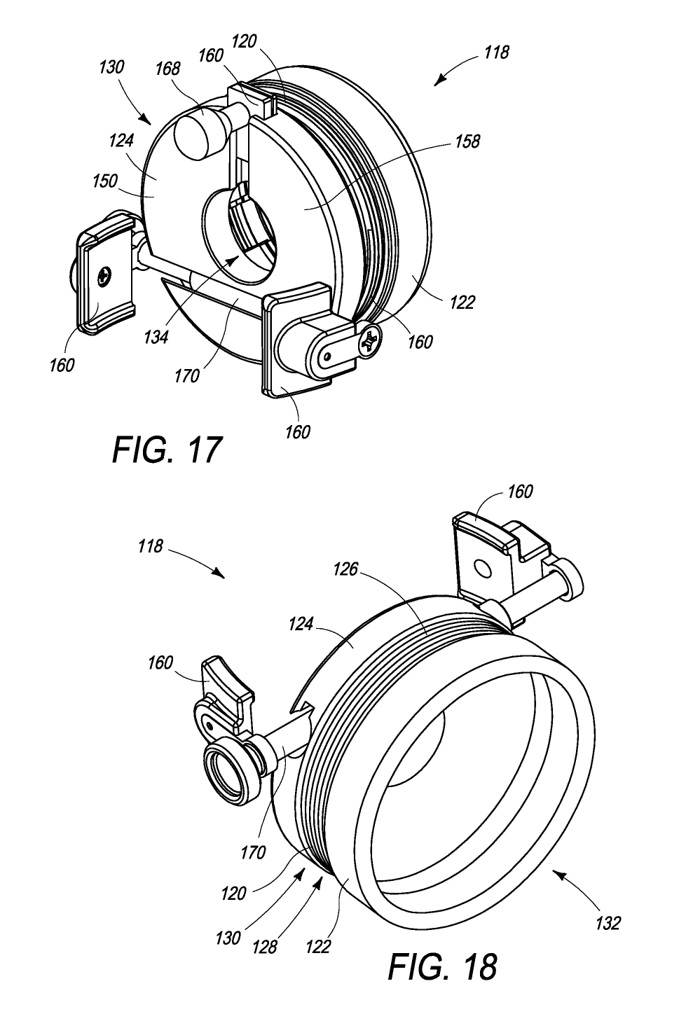

Optical scope coupler 118 may include a scope-receiving assembly 120, a locking mechanism 122, and a camera-receiving assembly 124, as shown in FIGS. 17-18. Scope-receiving assembly 120 may include any suitable structure configured to receive and/or enclose any suitable portion(s) of an optical scope, such as spotting scope 528. For example, the scope-receiving assembly may include a base structure 126 having a first end portion 128 and a second end portion 130. The first end portion may include a first opening 132 configured to receive any suitable portion(s) of spotting scope 528, such as eyepiece 538. The second end portion may be spaced from the first end portion and may include a second opening 134 that is, for example, co-axial with the first opening.

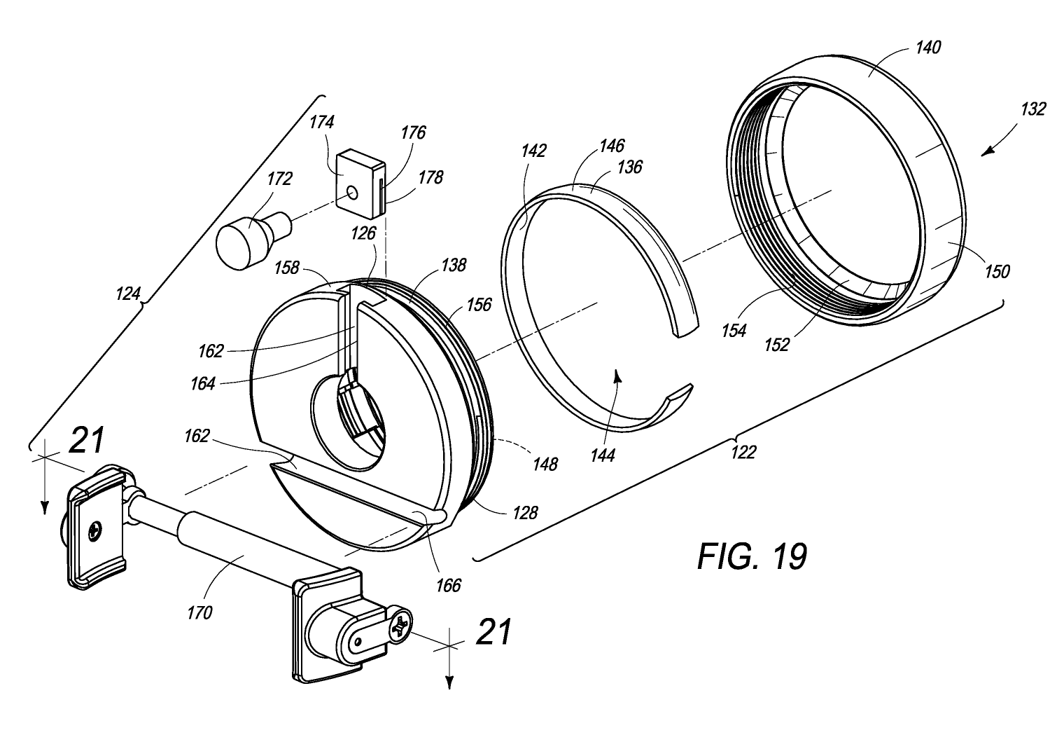

Locking mechanism 122 may include any suitable structure configured to selectively secure one or more portions of the spotting scope to the scope-receiving assembly such that the camera optical axis coincides with the scope optical axis when the optical scope coupler couples the smart phone camera and the spotting scope. For example, the locking mechanism may include a locking element 136, a base element 138, and an adjustment element 140, as shown in FIG. 19.

The locking element may include any suitable structure having at least one wall 142 that forms a portion of a circular aperture 144. For example, locking element 136 may include a ferrule or a first strip 146 having a shape that forms the portion of circular aperture 144. Base element 138 may support locking element 136 within first opening 132. The base element may include any suitable structure attached to, or formed with, first end portion 128. For example, base element 138 may include a base inclined surface 148, which may be similar or identical to base inclined surface 82 shown in FIGS. 8-9 and 11.

Adjustment element 140 may include any suitable structure configured to move locking element 136 between locking and unlocking positions as previously described for adjustment element 74. The adjustment element may, for example, include an outer ring 150 that is configured to be movably coupled, such as rotatably coupled, to first end portion 128 of base structure 126. The outer ring may include structure configured to move locking element between the locking and unlocking positions via rotation of the outer ring relative to the base structure. For example, outer ring 150 may include a ring inclined surface 152 and a plurality of threads 154 that are configured to engage plurality of threads 156 of first end portion 128. In some examples, locking element 136 may include a plurality of strips similar or identical to locking element 70, such as a first strip and one or more spacers described above and shown in FIGS. 13-14.

In some examples, optical scope coupler 118 does not include any lenses (or is free from one or more lenses), as discussed above for optical scope coupler 42. The optical scope coupler may include a protective cap (not shown), similar or identical to protective cap 110 shown in FIG. 8, which may be configured to be received by first opening 132 of base structure 126. In some examples, optical scope coupler 118 may include at least one filter and/or at least one support element (both not shown) similar or identical to filter 112 and support element 114 shown in FIG. 8.

Camera-receiving assembly 124 may include any suitable structure configured to receive and/or attach to smart phone 530. The camera-receiving assembly may be attached to, or formed with, second end portion 130 of scope-receiving assembly 120. Camera-receiving assembly 124 may, for example, include a base or base assembly 158 and a plurality of retention elements 160, as shown in FIGS. 17-18.

Base assembly 158 may include one or more channels 162 configured to receive one or more of retention elements 160. For example, the base assembly may include a first channel 164 and a second channel 166 that are configured to movably receive retention elements 160 shown in FIG. 19 and further described below. Base assembly 158 may sometimes be referred to as a “barrel.”

Retention elements 160 may include any suitable structure configured to secure smart phone 530 to base assembly 158 and/or to allow a user to adjust position of the smart phone to align the camera optical axis of the smart phone camera with the scope optical axis of the spotting scope. Additionally, or alternatively, retention elements 160 may be movably attached or movably connected to the base assembly and may be configured to contact and/or support one, two, three, or more sides of the smart phone. For example, retention elements 160 may include a post assembly 168 and a gripping or clamping mechanism 170, as shown in FIGS. 17-18.

Post assembly 168 may include a post (or end stop) 172 and a post base (or end stop slide) 174, as shown in FIG. 19. The post may be configured to contact and support one or more sides of the smart phone. In some examples, the post may be contoured to accommodate buttons on the smart phone. In other words, the post may be shaped such that the post does not depress a button of the smart phone when the post contacts and supports the side of the smart phone. Post 172 may be configured to be received in post base 174, such as via complementary threaded portions of the post and the post base.

The post base may be configured to be slidably received in first channel 164 of base assembly 158. The post base may include a base groove 176 that defines a locking portion 178 on a part of the post base opposed from the post. Post 172 may be configured to move locking portion 178 away from the post (and toward the first channel), such as via rotation of post 172, which may allow a user to selectively secure the post assembly in a particular position and/or orientation in first channel 164.

In some examples, post base 168 may be configured to be received in first channel 164 in different orientations. For example, post base 168 shown in FIG. 17 may be configured such that it can be slid out the first channel, rotated 180 degrees (such as along an axis parallel to the axis of the first and/or second openings) and reinstalled in the first channel. This may provide for a different position for post 172 when post 172 is received in an off centered part of the post base. Post assembly 168 may sometimes be referred to as a “first retention element” and post base 168 may be referred to as a “first end portion” of the first retention element.

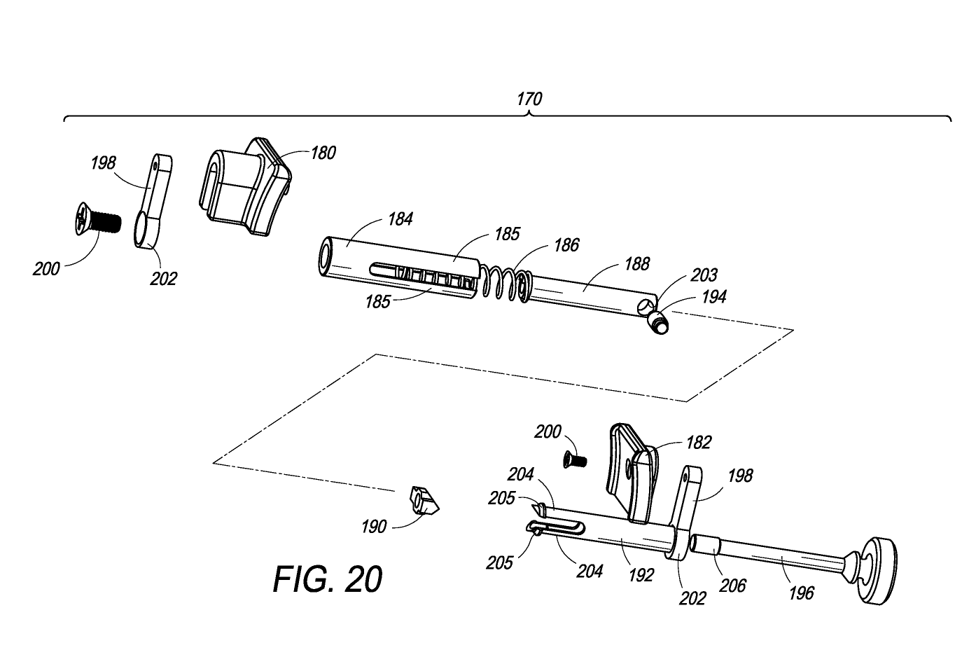

Clamping mechanism 170 may include any suitable structure configured to contact and support two or more sides of smart phone 530, such as two opposed sides of the smart phone. For example, clamping mechanism 170 may include a first gripper 180, a second gripper 182, an outer sleeve 184 having outer sleeve fingers 185, a bias element (or spring) 186, a plunger 188, a wedge or jammer 190, an inner sleeve 192, a retainer or pin 194, and an adjuster 196, as shown in FIG. 20.

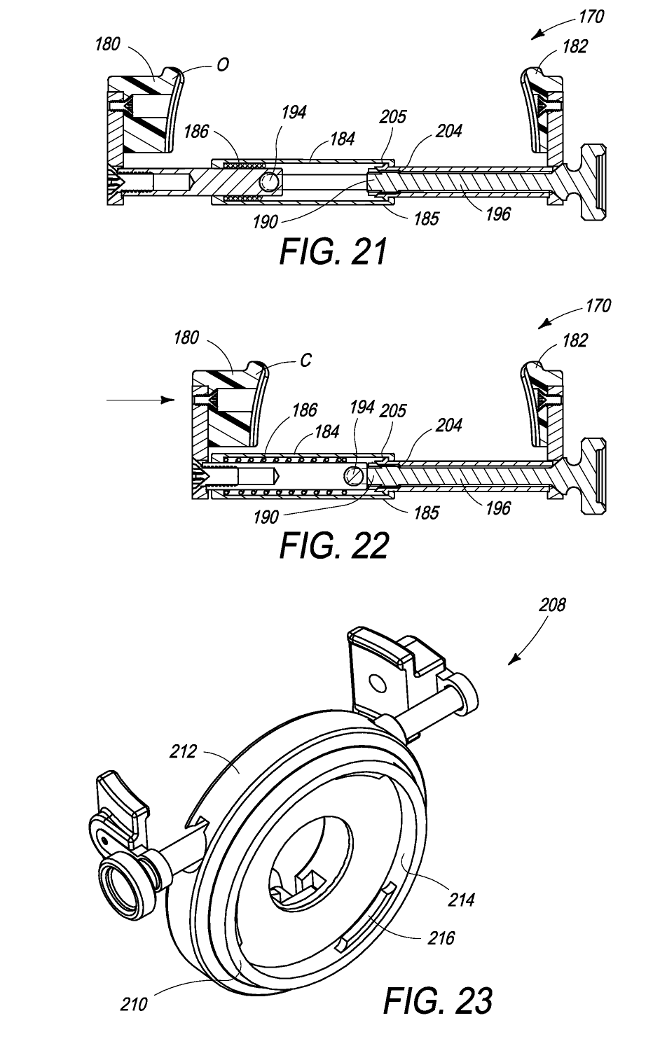

The first and second grippers may be shaped to retain and/or secure the smart phone to the base assembly. For example, the grippers may be curved and/or inclined to provide a force toward the base assembly. First and second grippers 180 and 182 may be attached to the outer and inner sleeves, respectively, via arms 198 and mounting elements 200. The arms may include arm end portions 202 configured to be slidably received in second channel 166 of base assembly 158. The arm end portions also may be shaped to prevent rotation of the grippers about the longitudinal axis of the second channel. Outer sleeve 184 may be configured to be slidably received in second channel 166. Plunger 188 may include a plunger hole 203 sized to receive pin 194. Spring 186 may rest on pin 194. The spring may be configured to urge first gripper toward the second gripper (or from an open position O to a closed position C), as shown in FIGS. 21-22.

Inner sleeve 192 may include inner sleeve fingers 204. Those fingers may include barbed end portions 205 configured to attach to the outer sleeve, as shown in FIGS. 21-22. Jammer 190 may be configured and/or shaped to be received in the second channel and to prevent clamping mechanism from rotating, such as about a longitudinal axis of the second channel. Adjuster 196 may be configured to move jammer 190 toward or away from fingers 204. For example, an adjuster end portion 206 and the jammer may include complementary threaded portions. Jammer 190 may be configured to spread fingers 204 when moved toward those fingers by the adjuster, which may cause one or more of fingers 204 to spread fingers 185 of the outer sleeve to contact the second channel and secure the clamping mechanism in a particular position along the second channel.

Although clamping mechanism 170 is shown to include a plurality of discrete elements, any combination of two or more of those elements may be formed as single unitary elements. For example, pin 194 may be formed with the plunger, and/or arm 198 of gripper 182 may be formed with the inner sleeve, etc. Additionally, although clamping mechanism 170 is shown to include a spring-biased gripper, the clamping mechanism may alternatively, or additionally, include any suitable structure configured to contact and support two or more sides of smart phone 530. For example, the clamping mechanism may include a screw clamp (not shown) without a spring or bias element.

The first and second grippers, arms, and mounting elements may sometimes be collectively referred to as “second and third retention elements.” The outer sleeve, spring, plunger, inner sleeve, and/or pin may sometimes be referred collectively as a “connector assembly” to connect the first and second grippers (or connect the arm end portions of those grippers). The jammer, fingers of the inner sleeve, and the adjuster may sometimes be referred to as a “locking assembly” to prevent sliding of the connector assembly relative to the base assembly. Although camera-receiving assembly 124 is shown to include particular retention elements 160, any suitable structure configured to contact and/or support two or more sides of the smart phone may alternatively, or additionally, be used, such as structure described in the present disclosure.

In use, a user of optical scope coupler 118 may position base structure 126 to partially enclose (or fully enclose) the eyepiece of the spotting scope. The user may install one or more spacers depending on the diameter of the eyepiece. The user may rotate outer ring 150 to move locking element 136 into the locking position in which the wall of the locking element fits snugly around a perimeter (or a portion of the perimeter) of the enclosed eyepiece. The user may rotate or adjust post 172 to unlock the post assembly and slide the post assembly along the first channel to a desired position along that channel. Alternatively, the user may remove post assembly 168 from first channel 164 and reinstall the post assembly in a different orientation. The user may rotate or adjust post to secure the post assembly in the desired position along the first channel.

The user may install the smart phone so that one side rests on the post and the grippers support opposed sides that are orthogonal to the side supported by the post. The user may move the first gripper away from the second gripper (and against the urging of the bias element) as the user is installing the smart phone. The user may release the first gripper after installing the phone such that the first and second gripper support the opposed sides.

The user may rotate or adjust adjuster 196 of clamping mechanism 170 to move the clamping mechanism along second channel 166 to a desired position along that channel such that the camera optical axis of the smart phone camera is aligned or coincides with the scope optical axis of the spotting scope. If necessary, the user may readjust the post assembly along first channel 164. When the optical scope coupler is not being used but it is desired to leave the coupler attached to the spotting scope, the user may move the first gripper away from the second gripper (and against the urging of the bias element) and remove the smart phone. The smart phone may be reinstalled following the above described procedure and/or other variations of the procedure. The above procedure may be modified to add, omit, alter, and/or replace one or more steps within the scope of the present disclosure.

Another example of optical scope coupler 30 is generally indicated at 208 in FIG. 23. Unless explicitly stated otherwise, optical scope coupler 208 may include one or more components of one or more other optical scope couplers described in the present disclosure. Optical scope coupler 208 may include a scope-receiving assembly 210 and a camera-receiving assembly 212.

The scope-receiving assembly may include a lens mounting plate 214. The lens mounting plate may be configured to receive, for example, optical scope coupler 42 shown in FIGS. 4-7. For example, lens mounting plate 214 may include a plurality of tabs 216 or a plurality of threads (not shown). Camera-receiving assembly 212 may include structure similar or identical to camera-receiving assembly 124 shown in FIGS. 17-22.

The disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where any claim recites “a” or “a first” element or the equivalent thereof, such claim should be understood to include incorporation of one or more such elements, neither requiring nor excluding two or more such elements.

Inventions embodied in various combinations and subcombinations of features, functions, elements, and/or properties may be claimed through presentation of new claims in a related application. Such new claims, whether they are directed to a different invention or directed to the same invention, whether different, broader, narrower or equal in scope to the original claims, are also regarded as included within the subject matter of the inventions of the present disclosure.

1. A camera accessory configured to couple a camera having a camera optical axis and a scope having a scope optical axis, the camera including a lens mounting plate, comprising:
a scope-receiving assembly having a first end portion configured to receive a portion of the scope and a second end portion spaced from the first end portion;
a camera-receiving assembly attached to, or formed with, the second end portion and including a lens mount configured to connect to the lens mounting plate of the camera; and
a locking mechanism configured to selectively secure the portion of the scope to the scope-receiving assembly such that, when the camera is attached to the camera-receiving assembly and when the scope is received by the scope-receiving assembly, the camera optical axis coincides with the scope optical axis, the locking mechanism including:
a locking element having at least one wall that forms a portion of a circular aperture, and
an adjustment element configured to move the locking element between a locking position in which the circular aperture has a first diameter such that the at least one wall fits snugly around at least a substantial portion of a perimeter of the portion of the scope, and an unlocking position in which the circular aperture has a second diameter larger than the first diameter such that the at least one wall is spaced from the at least a substantial portion of a perimeter of the portion of the scope.

2. The camera accessory of claim 1, wherein the locking element includes a strip having a shape that forms the portion of the circular aperture.

3. The camera accessory of claim 2, wherein the adjustment element includes an outer ring rotatably coupled to the first end portion of the scope-receiving assembly and configured to move the locking element between the locking and unlocking positions via rotation of the outer ring relative to the scope-receiving assembly.

4. The camera accessory of claim 3, wherein the outer ring includes an inclined surface configured to contact and move the locking element between the locking and unlocking positions via rotation of the outer ring relative to the scope-receiving assembly.

5. The camera accessory of claim 3, wherein the locking element includes first and second strips, the first strip having a first shape that forms a portion of a first circular aperture, the second strip having a second shape that forms the portion of the circular aperture and that nests within the first circular aperture.

6. The camera accessory of claim 5, wherein one of the first and second strips includes a groove configured to receive a portion of the other of the first and second strips when the second strip is nested within the first strip.

7. The camera accessory of claim 3, wherein the locking element includes first, second, and third strips, the first strip having a first shape that forms a portion of a first circular aperture, the second strip having a second shape that forms a portion of a second circular aperture and that nests within the first circular aperture, and the third strip having a third shape that forms the portion of the circular aperture and that nests within the second circular aperture.

8. The camera accessory of claim 1, wherein the camera accessory is free from one or more lenses.

9. The camera accessory of claim 1, where the camera includes a charge-coupled device (CCD) configured to capture images and the scope includes an eyepiece, wherein the camera accessory is free from one or more lenses such that the camera accessory is configured to couple the camera and the scope without one or more lenses disposed between the CCD and the eyepiece.

10. The camera accessory of claim 1, wherein the camera-receiving assembly includes a filter configured to protect interior components of the camera when the camera is connected to the camera-receiving assembly and when the scope is not received by the scope-receiving assembly.

11. The camera accessory of claim 1, where the scope includes an adjustment ring to adjust one of a focus and a focal length, wherein, when the scope is received by the scope-receiving assembly, the (a) scope-receiving assembly encloses the adjustment ring and (b) perimeter of the portion of the scope is adjacent the adjustment ring such that the at least one wall does not contact the adjustment ring in the locking position.

12. The camera accessory of claim 11, wherein the scope-receiving assembly further includes a hole allowing a user to access the adjustment ring external the scope-receiving assembly when the scope is received by the scope-receiving assembly.

13. The camera accessory of claim 1, wherein the camera-receiving assembly includes a plurality of tabs configured to be received in the lens mounting plate.

14. The camera accessory of claim 1, wherein the camera-receiving assembly includes a plurality of threads configured to connect to the lens mounting plate.

15. A camera accessory configured to couple a smart phone having a camera with a camera optical axis and a scope having a scope optical axis, the smart phone including top and bottom surfaces and a plurality of sides, comprising:
a scope-receiving assembly having a first end portion configured to receive a portion of the scope and a second end portion spaced from the first end portion;
a camera-receiving assembly attached to the second end portion and configured to receive the smart phone, the camera-receiving assembly including:
a base, and
a plurality of retention elements movably attached to the base and configured to contact and support two or more sides of the plurality of sides; and
a locking mechanism configured to selectively secure the portion of the scope to the scope-receiving assembly, the locking mechanism including:
a locking element having at least one wall that forms a portion of a circular aperture, and
an adjustment element configured to move the locking element between a locking position in which the circular aperture has a first diameter such that the at least one wall fits snugly around at least a substantial portion of a perimeter of the portion of the scope, and an unlocking position in which the circular aperture has a second diameter larger than the first diameter such that the at least one wall is spaced from the at least a substantial portion of a perimeter of the portion of the scope
the camera-receiving assembly and the locking mechanism being configured such that, when the smart phone having a camera is received by the camera-receiving assembly and the portion of the scope is received by the scope-receiving assembly, the camera optical axis coincides with the scope optical axis.

16. The camera accessory of claim 15, wherein the plurality of retention elements includes first, second, and third retention elements, the first retention element configured to contact and support a first side of the plurality of sides, the second and third retention elements configured to contact and support second and third opposed sides of the plurality of sides.

17. The camera accessory of claim 16, wherein the first retention element includes a first end portion and the base includes a first channel, the first end portion of the first retention element being sized to be slidably received in the first channel.

18. The camera accessory of claim 17, wherein the second and third retention elements include second and third end portions and the base includes a second channel, the second and third end portions of the second and third retention elements being sized to be slidably received in the second channel.

19. The camera accessory of claim 18, wherein the camera-receiving assembly further includes a connector assembly configured to connect the second end portion of the second retention element to the third end portion of the third retention element, the connector being sized to be slidably received in the second channel.

20. The camera accessory of claim 19, wherein the connector assembly includes a locking assembly configured to prevent sliding of the connector relative to the base.

21. The camera accessory of claim 19, wherein the second retention element is slidably connected to the connector assembly, wherein the connector assembly further includes a bias element configured to urge the second retention element toward the third retention element.

22. The camera accessory of claim 15, wherein the locking element includes a strip having a shape that forms the portion of the circular aperture, and wherein the adjustment element includes an outer ring rotatably coupled to the first end portion of the scope-receiving assembly and configured to move the locking element between the locking and unlocking positions via rotation of the outer ring relative to the scope-receiving assembly.
